(19) United States
(12) Patent Application Publication
(10) Pub. No.: US 2015/0085331 A1
(43) Pub. Date: Mar. 26, 2015

(54) WIDE-VIEWING ANGLE HOLOGRAPHIC DISPLAY APPARATUS

(71) Applicant: Electronics and Telecommunications Research Institute, Daejeon (KR)

(72) Inventor: Byung Gyu CHAE, Daejeon (KR)

(73) Assignee: Electronics and Telecommunications Research Institute, Daejeon (KR)

(21) Appl. No.: 14/216,467

(22) Filed: Mar. 17, 2014

(30) Foreign Application Priority Data
Sep. 23, 2013 (KR) 10-2013-0112495
Feb. 10, 2014 (KR) 10-2014-0015041

(51) Int. Cl. G03H 1/26; G03H 1/22

(52) U.S. Cl. CPC G03H 1/2645; G03H 1/2294; G03H 2001/2655
USPC 359/9

(57) ABSTRACT

A holographic display apparatus is provided. The holographic display apparatus may include an input optical unit to illuminate coherent parallel light to a spatial light modulator (SLM), the SLM to generate a plurality of hologram-modulated diffraction beams by illuminating the coherent parallel light in a plurality of directions, or to generate hologram-modulated higher-order diffraction beams by illuminating the coherent parallel light in a single direction, and an optical imaging unit to reproduce at least one holographic three-dimensional (3D) image with different viewpoints on a single imaging area, using the generated at least one diffraction beam.

### CROSS-REFERENCE TO RELATED APPLICATION

This application claims the benefit of Korean Patent Application No. 10-2013-0112495, filed on Sep. 23, 2013, and Korean Patent Application No. 10-2014-0015041, filed on Feb. 10, 2014, in the Korean Intellectual Property Office, the disclosure of which is incorporated herein by reference.

### BACKGROUND

1. Field of the Invention

The present invention relates to a holographic display apparatus, and more particularly, to a holographic display apparatus for reproducing a holographic three-dimensional (3D) image at a wide viewing angle.

2. Description of the Related Art

A holographic display encodes hologram interference fringes on a spatial light modulator (SLM), and reproduces a three-dimensional (3D) image by illuminating a coherent light to the SLM. Since a viewing angle of a reproduced image is determined based on resolution of a display device, an SLM with a submicrometer pixel size may be required to secure a wide visual field enabling viewing of a 3D image. However, resolution of a liquid crystal display (LCD) or a digital micromirror device (DMD) that is currently used as a holographic display device, is not enough to form a sufficient viewing angle.

Recently, to expand a viewing angle of a holographic image, researches are mainly conducted on a method of spatially or temporally multiplexing an SLM. For example, by arranging a plurality of SLMs in the form of a curve, a viewing angle may be significantly increased. However, when a plurality of holograms is spatiotemporally extended, an extremely large amount of hologram data is still required, and a structure of a display apparatus becomes complicated.

Accordingly, to commercialize a holographic display, there is a need to develop a display apparatus for increasing a viewing angle of a holographic image to be reproduced, while efficiently dealing with holographic image data using a current data processing technology.

### SUMMARY

According to an aspect of the present invention, there is provided a holographic display apparatus, including: an input optical unit to illuminate coherent parallel light a spatial light modulator (SLM) in an arbitrary direction; the SLM to spatially modulate the illuminated coherent parallel light, and to generate a diffraction beam; and an optical imaging unit to reproduce at least one holographic three-dimensional (3D) image with different viewpoints on a single imaging area, using the generated at least one diffraction beam.

The input optical unit may include a light source unit to generate the coherent parallel light, and a light illuminator to enable the coherent parallel light to be incident on the SLM in a plurality of directions.

The light source unit may generate the coherent parallel light, using at least one of red, green and blue laser devices, and red, green and blue light emitting diode (LED) devices.

The light source unit may include a white light source device including at least one of a white light laser and a white LED.

The light illuminator may enable a plurality of coherent parallel lights to be incident at an arbitrary angle with respect to a vertical direction of the SLM, using temporal multiplexing or spatial multiplexing.

The SLM may include a display panel to encode digital holographic interference fringes. The SLM may spatially modulate at least one of a phase, an amplitude, and a complex amplitude of the coherent parallel light.

The SLM may encode Fourier-transformed data of a Fourier hologram by generated by considering deformation of a spatial frequency domain, so that a distortion of the reproduced holographic 3D image may be removed. The distortion may occur at a diffraction angle that does not correspond to a paraxial approximation with respect to an optical axis of a vertical direction of the SLM.

The optical imaging unit may include at least two Fourier lenses and a spatial filter. The optical imaging unit may reproduce the at least one holographic 3D image on the imaging area, using the at least two Fourier lenses and the spatial filter.

The SLM may be located in a front focal plane of a first Fourier lens. The first Fourier lens may enable holographic interference fringes to be formed on a rear focal plane, using the at least one diffraction beam generated by the SLM. The holographic interference fringes may be replicated and arranged in a horizontal axis direction according to a propagating angle of the diffraction beam with respect to an optical axis.

A second Fourier lens may reproduce the at least one holographic 3D image on an imaging area within a predetermined distance from a rear focal plane of the second Fourier lens, using beams diffracted from holographic interference fringes lying in a common focal plane of two Fourier lens.

The spatial filter may be located in a common focal plane of two Fourier lenses, may remove noise of higher-order diffraction beams and unmodulated beams, may selectively transmit the at least one diffraction beam, and may adjust an intensity of each of the at least one diffraction beam.

When the SLM is disposed in a position different from a focal distance of the first Fourier lens, the optical imaging unit may reproduce the holographic 3D image through a screen lens located in an imaging plane.

The optical imaging unit may generate a color moving image by applying at least one of a time-division multiplexing reproduction scheme and a spatial multiplexing reproduction scheme through an RGB optical system.

According to another aspect of the present invention, there is provided a holographic display apparatus, including: a light source module to generate a single coherent parallel light; an SLM to spatially modulate the generated coherent parallel light, and to generate the higher-order diffraction beams; and an optical imaging unit to reproduce at least one holographic 3D image with different viewpoints on a single imaging area, using the generated at least one higher-order diffraction beam.

The light source module may generate the coherent parallel light, using at least one of red, green and blue laser devices, and red, green and blue LED devices.

The light source module may include a white light source device including at least one of a white light laser and a white LED.

The SLM may include a display panel that has a pixel structure and that is used to encode digital holographic interference fringe. The SLM may generate the higher-order diffraction beams through the pixel structure of the display panel. The pixel structure may be designed based on at least one of a distribution and an intensity of the at least one higher-order diffraction beam.

The optical imaging unit may include at least two Fourier lenses and a spatial filter. The optical imaging unit may reproduce the at least one holographic 3D image on the imaging area, using the at least two Fourier lenses and the spatial filter.

The SLM may be located in a front focal plane of a first Fourier lens. The first Fourier lens may enable holographic interference fringes to be formed on a rear focal plane, using the at least one higher-order diffraction beam generated by the SLM. The holographic interference fringes may be replicated and arranged in a horizontal axis direction based on an angle at which the higher-order diffraction beam travels with respect to an optical axis. A second Fourier lens may reproduce the at least one holographic 3D image on an imaging area within a predetermined distance from a rear focal plane of the second Fourier lens, using beams diffracted from holographic interference fringes lying in a common focal plane of two Fourier lenses.

When the SLM is disposed in a position different from a focal distance of the first Fourier lens, the optical imaging unit may reproduce a holographic 3D image through a screen lens located in an imaging plane.

### EFFECT

According to embodiments of the present invention, it is possible to achieve wide visualization of a holographic three-dimensional (3D) image by generating diffraction beams traveling in various angles with respect to an optical axis in a single spatial light modulator (SLM), and by reproducing at least one holographic 3D image with different parallaxes on a single imaging area through an optical imaging unit.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a change in an imaging area enabling viewing of a holographic three-dimensional (3D) image, based on an incidence angle of coherent parallel light according to an embodiment of the present invention;

FIG. 2 is a diagram illustrating a 3D reproduction hologram reproduction image for a plurality of diffraction beams generated from a Fourier hologram according to an embodiment of the present invention;

FIG. 3 is a diagram illustrating a wide-viewing angle holographic display apparatus using a plurality of diffraction beams according to an embodiment of the present invention;

FIG. 4 is a diagram illustrating a wide-viewing angle holographic display apparatus using coherent parallel light incident at various angles according to an embodiment of the present invention;

FIG. 5 is a diagram illustrating an example of generating coherent parallel light incident at various angles with respect to a vertical direction of a spatial light modulator (SLM) according to an embodiment of the present invention;

FIG. 6 is a flowchart illustrating a wide-viewing angle holographic display method according to an embodiment of the present invention;

FIG. 7 is a diagram illustrating a wide-viewing angle holographic display apparatus using higher-order diffraction beams according to an embodiment of the present invention;

FIG. 8 is a diagram illustrating a wide-viewing angle holographic display apparatus using a screen lens, based on higher-order diffraction beams according to an embodiment of the present invention;

FIG. 9 is a diagram illustrating a pixel structure of an SLM according to an embodiment of the present invention; and

FIG. 10 is a diagram illustrating a relation between a higher-order diffraction beam and a holographic image spectrum distribution according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

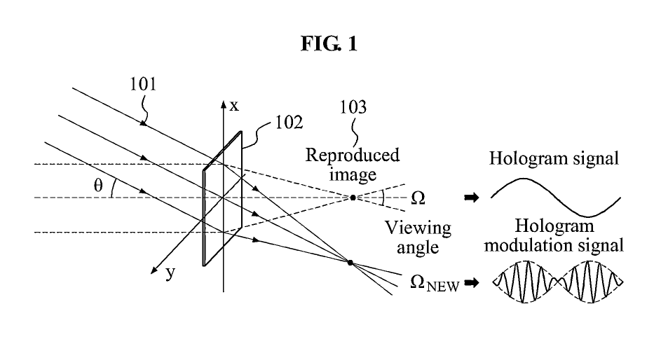

FIG. 1 is a diagram illustrating a change in an imaging area enabling viewing of a holographic three-dimensional (3D) image, based on an incidence angle of coherent parallel light according to an embodiment of the present invention.

FIG. 1 illustrates a change in a reproduced image for an on-axis point hologram according to an incidence angle of coherent parallel light. Referring to FIG. 1, coherent parallel light 101 may be incident at an arbitrary angle θ on a spatial light modulator (SLM) 102 on which a hologram is displayed, and a holographic 3D image with different viewpoints may be reproduced on a single imaging area 103. Coaxial waves, vertically incident on a hologram, may be used to generate a holographic 3D image in the imaging area 103 located on a central axis. On the other hand, obliquely incident off-axis waves may be used to generate a holographic 3D image in a position out of the central axis.

Since an area enabling viewing of a holographic 3D image is determined based on a direction in which diffraction light travels, an observer may view a reproduced image with different parallaxes. Accordingly, a viewing angle may be changed. Obliquely incident light may act as a modulated carrier wave of an off-axis holography, and may enable reproduction of a holographic 3D image with various viewpoints.

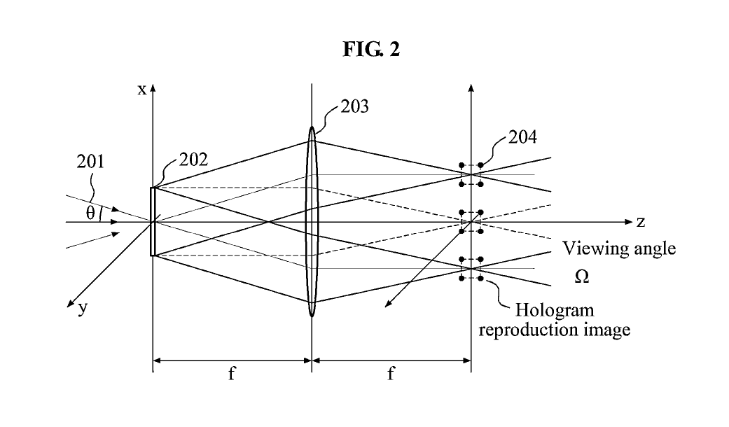

FIG. 2 is a diagram illustrating a 3D reproduction hologram reproduction image for a plurality of diffraction beams generated from a Fourier hologram according to an embodiment of the present invention.

FIG. 2 illustrates a change in a Fourier hologram reproduction image according to an incidence angle of parallel light. In FIG. 2, coherent parallel light 201 may be incident on an SLM 202 at an arbitrary angle, and a holographic 3D image 204 may be reproduced through a Fourier lens 203 with a focal distance f.

Referring to FIG. 2, beams diffracted from a hologram located in a front focal plane of the Fourier lens 203, reproduce a 3D image in the vicinity of a rear focal plane of the Fourier lens 203. The front focal plane and the rear focal plane of the Fourier lens 203 may be shown in a left side and a right side of FIG. 2, respectively. Light incident at an arbitrary angle θ with respect to a central axis z may form a 3D image in a position shifted by f₁ sin θ in an x-axial direction in the rear focal plane. The 3D image may be reproduced as a perfect object image that is not deformed, as shown in FIG. 2, unlike a phenomenon of a distortion in a Fresnel hologram reproduction. Each diffraction beam may travel in a coaxial direction in the rear focal plane, and accordingly 3D images with the same parallax may be formed.

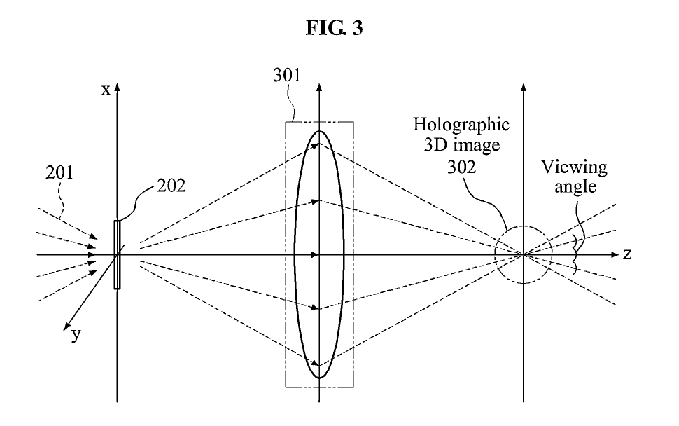

FIG. 3 is a diagram illustrating a wide-viewing angle holographic display apparatus using a plurality of diffraction beams according to an embodiment of the present invention.

The wide-viewing angle holographic display apparatus of FIG. 3 may realize wide visualization of a holographic 3D image by reproducing, using an optical imaging unit 301, at least one holographic 3D image with different parallaxes on a single imaging area 302 from diffraction beams traveling in various directions. In the present disclosure, a wide-viewing angle holographic display apparatus may be referred to as a “holographic display apparatus.”

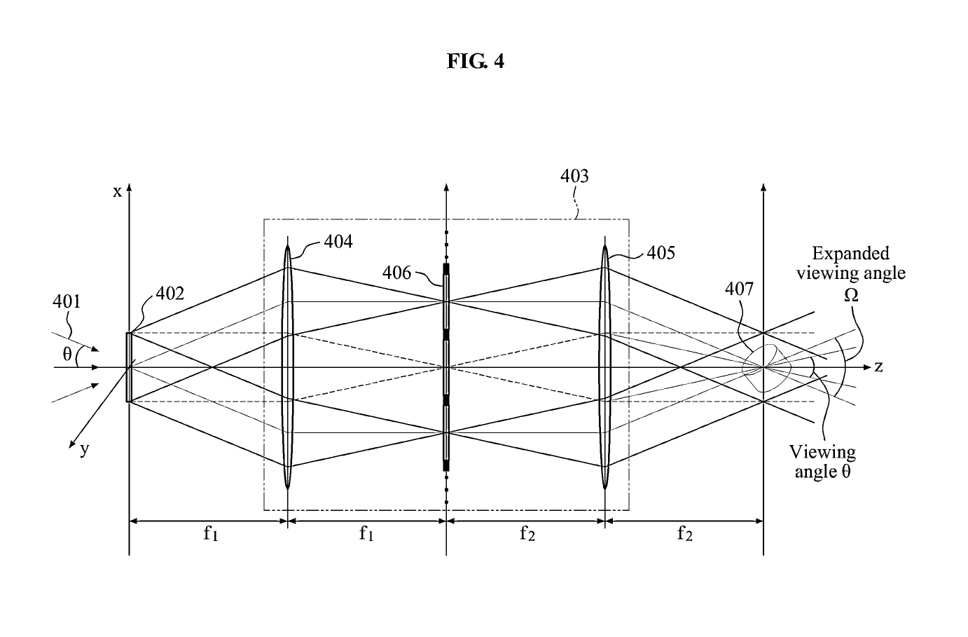

FIG. 4 is a diagram illustrating a holographic display apparatus according to an embodiment of the present invention. The holographic display apparatus of FIG. 4 may enable coherent parallel light to be incident on an SLM 402 at various angles, and may generate diffraction beams traveling in various directions. Additionally, the holographic display apparatus of FIG. 4 may realize a wide viewing angle for a holographic 3D image by reproducing, using an optical imaging unit 403, at least one holographic 3D image with different viewpoints from each diffraction beam.

Referring to FIG. 4, the holographic display apparatus may include an input optical unit (not shown), the SLM 402, and the optical imaging unit 403. The input optical unit may illuminate coherent parallel light 401 to SLM 402 in an arbitrary direction. The SLM 402 may spatially modulate the coherent parallel light 401 illuminated in the arbitrary direction, and may generate diffraction beams. The optical imaging unit 403 may reproduce at least one holographic 3D image with different viewpoints on a single imaging area, using the generated diffraction beams.

The input optical unit may include a light source unit to generate the coherent parallel light 401, and a light illuminator to illuminate a plurality of coherent parallel lights to the SLM 402.

In an example, the light source unit may generate parallel light, using red, green and blue laser devices, or using red, green and blue light emitting diode (LED) devices. In another example, the light source unit may use a white light source device, for example, a white light laser, or a white LED. The light illuminator may provide a function of enabling a plurality of coherent parallel lights to be incident at an arbitrary angle with respect to a vertical direction of the SLM 402, using temporal multiplexing or spatial multiplexing.

The SLM 402 may include a display panel having a pixel structure to encode digital holographic interference fringes, for example, a liquid crystal display (LCD), and a digital micromirror device (DMD). The SLM 402 may modulate a phase, an amplitude, or a complex amplitude of coherent parallel light, and may reproduce a holographic 3D image.

The optical imaging unit 403 may include at least two Fourier lenses, for example, Fourier lenses 404 and 405 and a spatial filter 406. Additionally, the optical imaging unit 403 may reproduce at least one holographic 3D image with different viewpoints on a single imaging area, using the Fourier lenses 404 and 405 and the spatial filter 406. For example, the optical imaging unit 403 may reproduce at least one holographic 3D image with different viewpoints, for example a holographic 3D image 407, on the same single imaging area from each diffraction beam. Thus, wide visualization of a 3D image may be realized.

For example, when the SLM 402 is disposed in a position different from a focal distance of the first Fourier lens 404, the optical imaging unit 403 may reproduce a holographic 3D image through a screen lens located in an imaging plane.

The Fourier lens 404 with a focal distance f₁ may enable hologram interference fringes to be formed in a rear focal plane of the Fourier lens 404, using beams diffracted in the SLM 402 located in a front focal plane of the Fourier lens 404. The front focal plane and the rear focal plane may be shown in a left side and a right side of FIG. 4, respectively. The hologram interference fringes may be replicated and arranged in a horizontal axis direction, based on an angle at which diffraction beams travel with respect to an optical axis. For example, hologram interference fringes may be replicated and arranged in a position apart by f₁ sin θ in an x-axial direction according to an angle θ.

The Fourier lens 405 with a focal distance f₂ may reproduce at least one holographic 3D image with different viewpoints in a single imaging area within a predetermined distance from a rear focal plane of the Fourier lens 405, using beams diffracted from hologram interference fringes lying in a common focal plane of the Fourier lenses 404 and 405. For example, the Fourier lens 405 may enable the holographic 3D image 407 to be reproduced in a single imaging area near the rear focal plane of the Fourier lens 405.

The spatial filter 406 may be located in the common focal plane, and may remove noise of higher-order diffraction beams and unmodualted beams. Additionally, the spatial filter 406 may selectively transmit the generated diffraction beams, and may adjust an intensity of each of the generated diffraction beams.

The spatial filter 406 may use together a transparent screen to display the hologram interference fringes. For example, a transparent screen may be made by using polymer dispersed liquid crystal (PDLC) film.

A structure of the optical imaging unit 403 may not be limited to the above-described structure and accordingly, the optical imaging unit 403 may be configured to function as the above-described system in various lens combinations.

The holographic display apparatus of FIG. 4 may adjust a size and a viewing angle of a reproduced image by changing a focal distance of each of two Fourier lenses.

For example, when seamless images with different viewpoints are generated using a plurality of diffraction beams in the holographic display apparatus of FIG. 4, a sufficient wide viewing angle may be ensured. In this example, a Fourier lens may need to transmit light incident at a large angle, without an aberration.

The holographic display apparatus of FIG. 4 may enable light to be incident at an arbitrary angle in a y-axial direction, and may generate a holographic 3D image with different parallaxes. Accordingly, the holographic display apparatus of FIG. 4 may be implemented as a system for realizing a holographic 3D image with a full parallax.

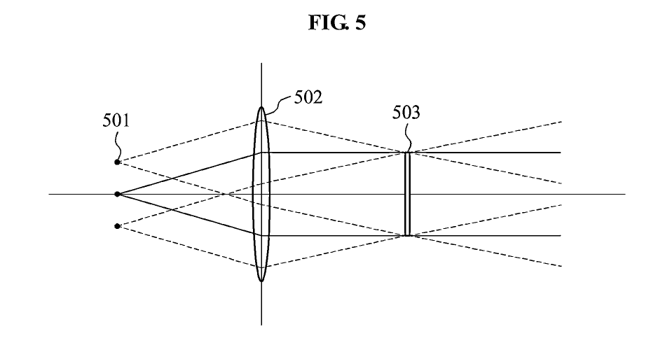

FIG. 5 is a diagram illustrating an example of generating coherent parallel light incident at various angles in a vertical direction of an SLM according to an embodiment of the present invention.

Referring to FIG. 5, a plurality of point light sources 501 may be arranged in a horizontal axis direction in a front focal plane of a convergent lens 502 that is shown in a left side of FIG. 5, and may generate coherent parallel light traveling in an arbitrary direction.

The coherent parallel light traveling in the arbitrary direction may be generated using various schemes, for example, a scheme of using a Galvano mirror, and the like.

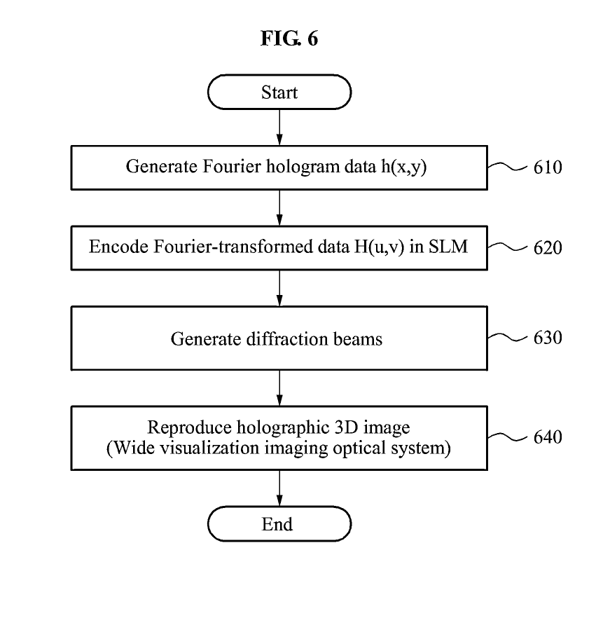

FIG. 6 is a flowchart illustrating a wide-viewing angle holographic display method according to an embodiment of the present invention.

Referring to FIG. 6, in operation 610, Fourier hologram data h(x,y) may be generated. In operation 620, Fourier-transformed data H(u,v) of the Fourier hologram data h(x,y) may be encoded in an SLM. In operation 630, a plurality of diffraction beams may be generated from the Fourier-transformed data H(u,v) in the SLM. In operation 640, a holographic 3D image may be reproduced by arranging hologram interference fringes in a rear focal plane of a Fourier lens, using the generated diffraction beams. A spatial frequency domain in the rear focal plane may be deformed at a diffraction angle that does not correspond to a paraxial approximation with respect to an optical axis of a vertical direction of the SLM. Accordingly, a distortion of the reproduced holographic 3D image may be removed by generating Fourier-transformed data of a Fourier hologram considering deformation of the spatial frequency domain.

A holographic display apparatus according to an embodiment of the present invention may configure an RGB optical system, and may generate a color moving image, using a time-division multiplexing reproduction scheme or a spatial multiplexing reproduction scheme. For example, an optical imaging unit may generate a color moving image by applying at least one of a time-division multiplexing reproduction scheme and a spatial multiplexing reproduction scheme to at least one holographic 3D image with different viewpoints.

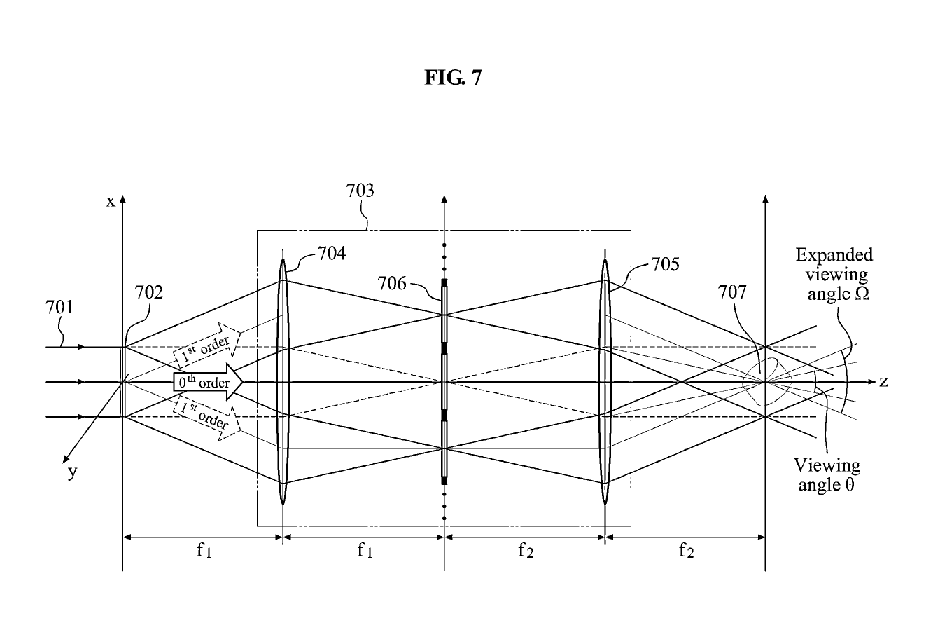

FIG. 7 is a diagram illustrating a wide-viewing angle holographic display apparatus using higher-order diffraction beams according to an embodiment of the present invention.

The holographic display apparatus of FIG. 7 may realize a wide-viewing angle holographic 3D image by a scheme of enabling single coherent parallel light to be incident on an SLM, generating higher-order diffraction beams traveling in various directions, and reproducing at least one holographic 3D image with different viewpoints from each diffraction beam using an optical imaging unit.

Referring to FIG. 7, the holographic display apparatus may include a light source module (not shown), an SLM 702, and an optical imaging unit 703. The light source module may generate single coherent parallel light 701. The SLM 702 may modulate the coherent parallel light 701, and may generate higher-order diffraction beams. The optical imaging unit 703 may reproduce at least one holographic 3D image with different viewpoints on a single imaging area, using the generated higher-order diffraction beams.

The light source module may generate parallel light using at least one of red, green and blue laser devices, and red, green and blue LED devices, or may include, for example, at least one white light source device, for example, a white light laser, or a white LED.

The SLM 702 may include a display panel with a pixel structure to encode digital hologram interference fringes. The pixel structure may be used to generate higher-order diffraction beams.

The SLM 702 may modulate at least one of a phase, an amplitude, or complex amplitude of coherent parallel light, and may reproduce a holographic 3D image.

The optical imaging unit 703 may include at least two lenses, for example Fourier lenses 704 and 705 and a spatial filter 706. The optical imaging unit 703 may reproduce at least one holographic 3D image with different viewpoints, for example a holographic 3D image 707, on a single imaging area, using the Fourier lenses 704 and 705, and a spatial filter 706. Thus, wide visualization of a 3D image may be realized.

The Fourier lens 704 with a focal distance f₁ may enable hologram interference fringes to be formed in a rear focal plane of the Fourier lens 704, using beams diffracted in the SLM 702 located in a front focal plane of the Fourier lens 704. The front focal plane of the Fourier lens 704 may be shown in a left side of FIG. 7. The hologram interference fringes may be replicated and arranged in a position apart by f₁ sin θ in an x-axial direction, depending on an angle θ at which diffraction beams travel with respect to an optical axis.

The Fourier lens 705 with a focal distance f₂ may reproduce the holographic 3D image 707 in a position near a rear focal plane of the Fourier lens 705 by transmitting beams diffracted from hologram interference fringes lying in a common focal plane of the Fourier lenses 704 and 705. The rear focal plane of the Fourier lens 705 may be shown in the right side of FIG. 7.

The spatial filter 706 may be located in the common focal plane. The spatial filter 706 may remove noise of DC beams, and the like, may selectively transmit desirable diffraction beams, and may adjust an intensity of a specific diffraction beam.

A structure of the optical imaging unit 703 may not be limited to the above-described structure and accordingly, the optical imaging unit 703 may be configured to function as the above-described system in various lens combinations.

A size and a viewing angle of a reproduced image may be adjusted by changing a focal distance of each of the at least two Fourier lenses

For example, when seamless images with different viewpoints are generated using a plurality of higher-order diffraction beams in the holographic display apparatus of FIG. 7, a sufficient wide viewing angle may be ensured. In this example, a Fourier lens may need to transmit light incident at a large angle, without an aberration.

The holographic display apparatus of FIG. 7 may enable light to be incident at an arbitrary angle in a y-axial direction, and may generate a holographic 3D image with different parallaxes. Accordingly, the holographic display apparatus of FIG. 7 may be implemented as a system for realizing a holographic 3D image with a full parallax.

The SLM 702 may encode Fourier-transformed data H(u,v) of Fourier hologram h(x,y). Additionally, the SLM 702 may generate a pattern array of hologram interference fringes in a rear focal plane of a Fourier lens, using higher-order diffraction beams from Fourier-transformed data. A spatial frequency domain in the rear focal plane may be deformed at an extremely large diffraction angle and accordingly, a distortion of a reproduced image may be removed by generating Fourier transform data of a Fourier hologram considering deformation of the spatial frequency domain.

The holographic display apparatus of FIG. 7 may configure an RGB optical system, and may realize a color moving image, using a time-division multiplexing reproduction scheme or a spatial multiplexing reproduction scheme.

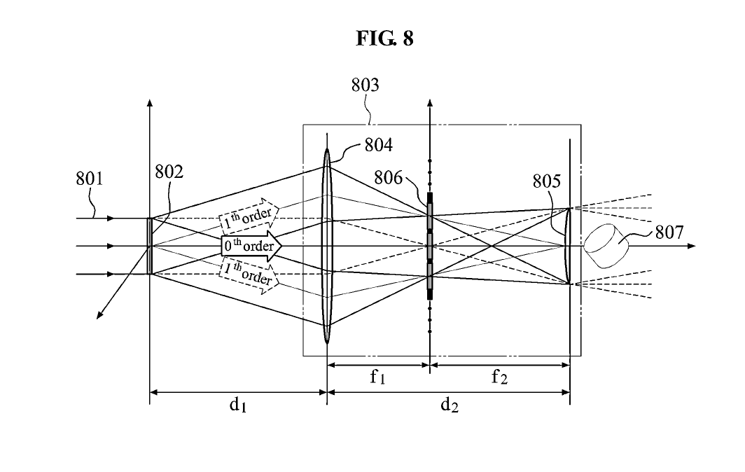

FIG. 8 is a diagram illustrating a wide-viewing angle holographic display apparatus using a screen lens, based on higher-order diffraction beams according to an embodiment of the present invention.

Referring to FIG. 8, the holographic display apparatus may include a light source module (not shown), an SLM 802, and an optical imaging unit 803. The light source module may generate coherent parallel light 801. The SLM 802 may modulate the generated coherent parallel light 801, and may generate higher-order diffraction beams. The optical imaging unit 803 may display at least one holographic 3D image with different viewpoints, using the generated higher-order diffraction beams.

The light source module may generate parallel light using at least one of red, green and blue laser devices, and red, green and blue LED devices, or may include, for example, at least one white light source device, for example, a white light laser, or a white LED.

The SLM 802 may include a display panel having a pixel structure to encode digital holographic interference fringes. The pixel structure may be used to generate higher-order diffraction beams.

The SLM 802 may modulate at least one of a phase, an amplitude, or a complex amplitude of coherent parallel light, and may reproduce a holographic 3D image.

The optical imaging unit 803 may include a Fourier lens 804, a screen lens 805, and a spatial filter 806. The optical imaging unit 803 may reproduce at least one holographic 3D image with different viewpoints, for example a holographic 3D image 807, on the same single imaging area from each diffraction beam. Thus, wide visualization of a 3D image may be realized.

The Fourier lens 804 with a focal distance f₁ may enable hologram interference fringes to be formed in a rear focal plane of the Fourier lens 804, using beams diffracted in the SLM 802. The SLM 802 may be located in a front focal plane of the Fourier lens 804, and may be spaced apart by a distance d₁ from the Fourier lens 804. The front focal plane of the Fourier lens 804 may be shown in a left side of FIG. 8, and the distance d₁ may be greater than the focal distance f₁. The hologram interference fringes may be replicated and arranged in a position apart by f₁ sin θ in an x-axial direction based on an angle θ at which diffraction beams travel with respect to an optical axis.

The Fourier lens 805 with a focal distance f₂ may reproduce the holographic 3D image 807 on an imaging area within a distance d₂, from hologram interference fringes lying in a common focal plane of the Fourier lenses 804 and 805.

The spatial filter 806 may be located in the common focal plane, and may remove noise of DC beams, and the like, may selectively transmit desirable diffraction beams, and may adjust an intensity of a specific diffraction beam.

In the holographic display apparatus of FIG. 8, a size of a reproduced image may be determined based on a ratio d₂/d₁ with respect to a size of an active panel for SLMs, and accordingly the size of the reproduced image may be adjusted to a desired size based on a combination of two lenses with different focal distances.

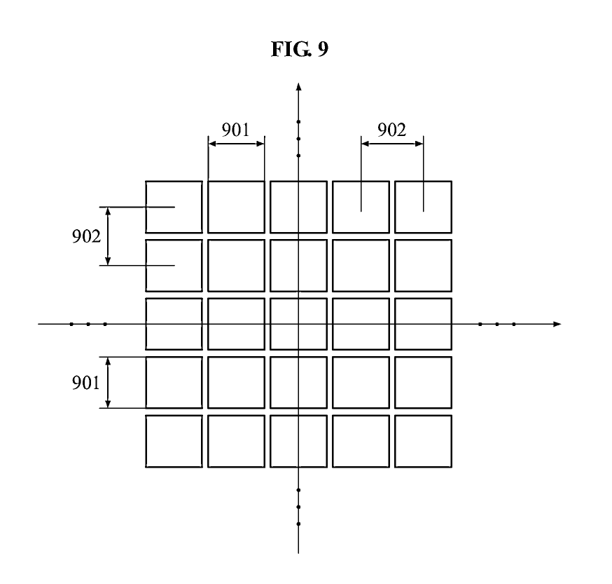

FIG. 9 is a diagram illustrating a pixel structure of an SLM according to an embodiment of the present invention.

FIG. 9 illustrates an example of a typical pixel structure of an SLM to generate higher-order diffraction beams. In FIG. 9, a pixel size 901, and a pixel interval 902 may be illustrated. As shown in FIG. 9, each of pixels may have a rectangular shape, and the pixels may be arranged in an array in an x-axial direction and a y-axial direction. For example, digital hologram data of 1 bit may be encoded on a single pixel. Various pixel structures may be designed, based on an intensity and distribution of higher-order diffraction beams. For example, a blazed diffraction grating structure, or a Damman diffraction grating structure may be used.

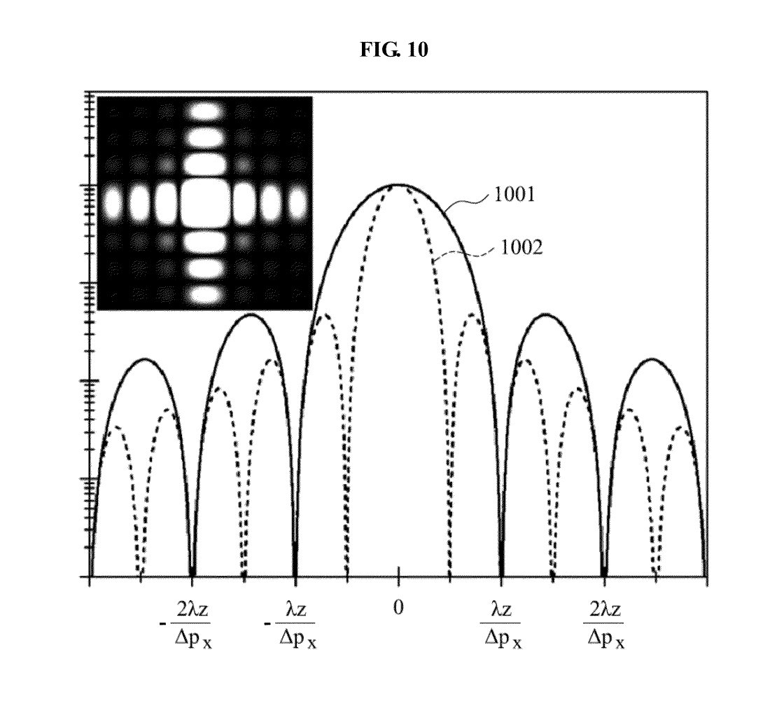

FIG. 10 is a diagram illustrating a relation between a higher-order diffraction beam 1001 and a holographic image spectrum distribution 1002 according to an embodiment of the present invention.

Referring to FIG. 10, a holographic image spectrum may be represented as a form modulated to a diffraction beam distribution. The higher-order diffraction beam 1001 may be expressed by a sinc function, and a width of the higher-order diffraction beam 1001 may be in proportion to a pixel size Δp of an SLM. In other words, as a pixel size decreases, a diffraction angle may increase. To evenly distribute the holographic image spectrum in each diffraction beam, the pixel size 901 and the pixel interval 902 of FIG. 9 may need to be approximately identical to each other.

As described above, according to embodiments of the present invention, by using a wide-viewing angle holographic display apparatus, a plurality of diffraction beams may be generated using a single SLM, and a reproduced image with various viewpoints may be generated. Thus, it is possible to realize wide visualization of a holographic 3D image.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A holographic display apparatus, comprising:
an input optical unit to illuminate coherent parallel light in an arbitrary direction;
a spatial light modulator (SLM) to spatially modulate the emitted coherent parallel light, and to generate a diffraction beam; and
an optical imaging unit to reproduce at least one holographic three-dimensional (3D) image with different viewpoints on a single imaging area, using the generated at least one diffraction beam.

2. The holographic display apparatus of claim 1, wherein the input optical unit comprises:
a light source unit to generate the coherent parallel light; and
a light illuminator to enable the coherent parallel light to be incident on the SLM in a plurality of directions.

3. The holographic display apparatus of claim 2, wherein the light source unit generates the coherent parallel light, using at least one of red, green and blue laser devices, and red, green and blue light emitting diode (LED) devices.

4. The holographic display apparatus of claim 2, wherein the light source unit comprises a white light source device comprising at least one of a white light laser and a white LED.

5. The holographic display apparatus of claim 2, wherein the light illuminator enables a plurality of coherent parallel lights to be incident at an arbitrary angle with respect to a vertical direction of the SLM, using temporal multiplexing or spatial multiplexing.

6. The holographic display apparatus of claim 1, wherein the SLM comprises a display panel to encode digital holographic interference fringes, and
wherein the SLM spatially modulates at least one of a phase, an amplitude, and a complex amplitude of the coherent parallel light.

7. The holographic display apparatus of claim 1, wherein the SLM generates and encodes Fourier-transformed data of a Fourier hologram, considering deformation of a spatial frequency domain at a diffraction angle that does not correspond to a paraxial approximation with respect to an optical axis of a vertical direction of the SLM, and removes a distortion of the reproduced at least one holographic 3D image.

8. The holographic display apparatus of claim 1, wherein the optical imaging unit comprises at least two Fourier lenses and a spatial filter, and
wherein the optical imaging unit reproduces the at least one holographic 3D image on the imaging area, using the at least two Fourier lenses, and the spatial filter.

9. The holographic display apparatus of claim 8, wherein the SLM is located in a front focal plane of a first Fourier lens, and
wherein the first Fourier lens enables holographic interference fringes to be formed on a rear focal plane, using the at least one diffraction beam generated by the SLM, and the holographic interference fringes are replicated and arranged in a horizontal axis direction according to a propagating angle of a diffraction beam with respect to an optical axis.

10. The holographic display apparatus of claim 8, wherein a second Fourier lens reproduces the at least one holographic 3D image on an imaging area within a predetermined distance from a rear focal plane of the second Fourier lens, using beams diffracted from holographic interference fringes lying in a common focal plane of two Fourier lenses.

11. The holographic display apparatus of claim 8, wherein the spatial filter located in a common focal plane of two Fourier lenses removes noise of higher-order diffraction beams and unmodulated beams, selectively transmits the at least one diffraction beam, and adjusts an intensity of each of the at least one diffraction beam.

12. The holographic display apparatus of claim 8, wherein, when the SLM is disposed in a position different from a position of a focal distance of the first Fourier lens, the optical imaging unit reproduces at least one holographic 3D image through a screen lens located in an imaging plane.

13. The holographic display apparatus of claim 1, wherein the optical imaging unit generates a color moving image by applying at least one of a time-division multiplexing reproduction scheme and a spatial multiplexing reproduction scheme through an RGB optical system.

14. A holographic display apparatus, comprising:
a light source module to generate a single coherent parallel light;
a spatial light modulator (SLM) to spatially modulate the generated coherent parallel light, and to generate at least one higher-order diffraction beam; and
an optical imaging unit to reproduce at least one holographic three-dimensional (3D) image with different viewpoints on a single imaging area, using the generated at least one higher-order diffraction beam.

15. The holographic display apparatus of claim 14, wherein the light source module generates the coherent parallel light, using at least one of red, green and blue laser devices, and red, green and blue light emitting diode (LED) devices, and
wherein the light source module comprises a white light source device comprising at least one of a white light laser and a white LED.

16. The holographic display apparatus of claim 14, wherein the SLM comprises a display panel that has a pixel structure and that is used to encode digital holographic interference fringes,
wherein the SLM generates at least one higher-order diffraction beam through the pixel structure of the display panel, and
wherein the pixel structure is designed based on at least one of a distribution and an intensity of the at least one higher-order diffraction beam.

17. The holographic display apparatus of claim 14, wherein the optical imaging unit comprises at least two Fourier lenses and a spatial filter, and
wherein the optical imaging unit reproduces the at least one holographic 3D image on the imaging area, using the at least two Fourier lenses, and the spatial filter.

18. The holographic display apparatus of claim 17, wherein the SLM is located in a front focal plane of a first Fourier lens,
wherein the first Fourier lens enables holographic interference fringes to be formed on a rear focal plane, using the at least one higher-order diffraction beam generated by the SLM, and the holographic interference fringes are replicated and arranged in a horizontal axis direction based on an angle at which the at least one higher-order diffraction beam travels with respect to an optical axis, and
wherein a second Fourier lens reproduces the at least one holographic 3D image on an imaging area within a predetermined distance from a rear focal plane of the second Fourier lens, using beams diffracted from holographic interference fringes lying in a common focal plane of the at least two Fourier lenses.

19. The holographic display apparatus of claim 17, wherein, when the SLM is disposed in a position different from a position of a focal distance of the first Fourier lens, the optical imaging unit reproduces a holographic 3D image through a screen lens located in an imaging plane.
